(19) United States
(12) Patent Application Publication
(10) Pub. No.: US 2006/0151676 A1
(43) Pub. Date: Jul. 13, 2006

(54) Apparatus for use in structural construction

(76) Inventor: Bryant Curtis Harvey, Ocean Springs, MS (US)

Correspondence Address: TERRY B. MORRIS, P.O. BOX 808, PASS CHRISTIAN, MS, 39571-0808, US

(21) Appl. No.: 11/035,341

(22) Filed: Jan. 13, 2005

(51) Int. Cl. F16B 1/00

(52) U.S. Cl. 248/229.15; 248/229.25

(57) ABSTRACT

An apparatus is disclosed which utilizes various clamps and clamping structures to adjustably securely engage two or more construction structural support members, providing in part the advantage of not having to weld or otherwise connect in a permanent-type manner such members during a construction process.

### FIELD OF THE INVENTION

The present invention relates to construction equipment and methods. More particularly, it relates to an apparatus which is useable in construction techniques to provide a secure temporary connection.

### BACKGROUND OF THE INVENTION

In many construction fields there is a need to temporarily provide structural frames of a structure under construction. For example, in ship building a metal frame structure is constructed to which is attached the additional components of construction, such as plates, pipes and other construction components. The frame is typically made of metal beams, such as I-beams and angle iron. To such a frame the additional components are positioned and fixed, but thereafter often requiring adjustments in the connections of the frame or components. To facilitate the frame components being securely fixed to the other components, the frame components themselves are welded or otherwise “permanently” connected. As construction progresses, these “permanent” connections are sometimes cut or otherwise disassembled and then welded additional times in the adjustment process. While such a methodology provides a secure connection which relative permanency facilitates the construction process, such methodology also incurs additional costs in materials, time and safety. There is needed an improved methodology in making these “permanent” connections.

### SUMMARY OF THE INVENTION

The present invention is an apparatus for securing a structural member (an I-beam, for example) relative to another structural member in a permanent-like, but temporary, secure connection. The apparatus has a clamp for securing to the structural member. This clamp comprises two clamp members. These clamp members have means to adjustably engage securely the clamp to the structural member in a variety of ways. A slide plate member is attached to this clamp. The plate member can adjustably securely engage the clamp and an accompanying support member. Also on this support member are brackets having means to adjustably engage the support member and having means to adjustably securely engage another structural member, thereby providing a secure connection that is readily and safely adjusted until a truly permanent connection is made.

### BRIEF DESCRIPTION OF THE FIGURES

FIG. 1 depicts an exploded view of one embodiment of the present apparatus secured to an I-beam.

FIG. 2 depicts an alternative clamp member for use in the FIG. 1 embodiment. FIGS. 3a and 3b depict side views of a clamp member of the aforementioned clamps used in the present invention.

FIGS. 4a and 4b depict side views of a complimentary clamp member to those depicted in FIGS. 3a and 3b.

FIG. 5 depicts a plate member used with the aforesaid clamp.

FIG. 6 depicts a clamp and arm used also with the FIG. 1 embodiment.

FIGS. 7a, 7b and 7c depict alternative clamps used also with the FIG. 1 embodiment.

### DESCRIPTION OF PREFERRED EMBODIMENTS

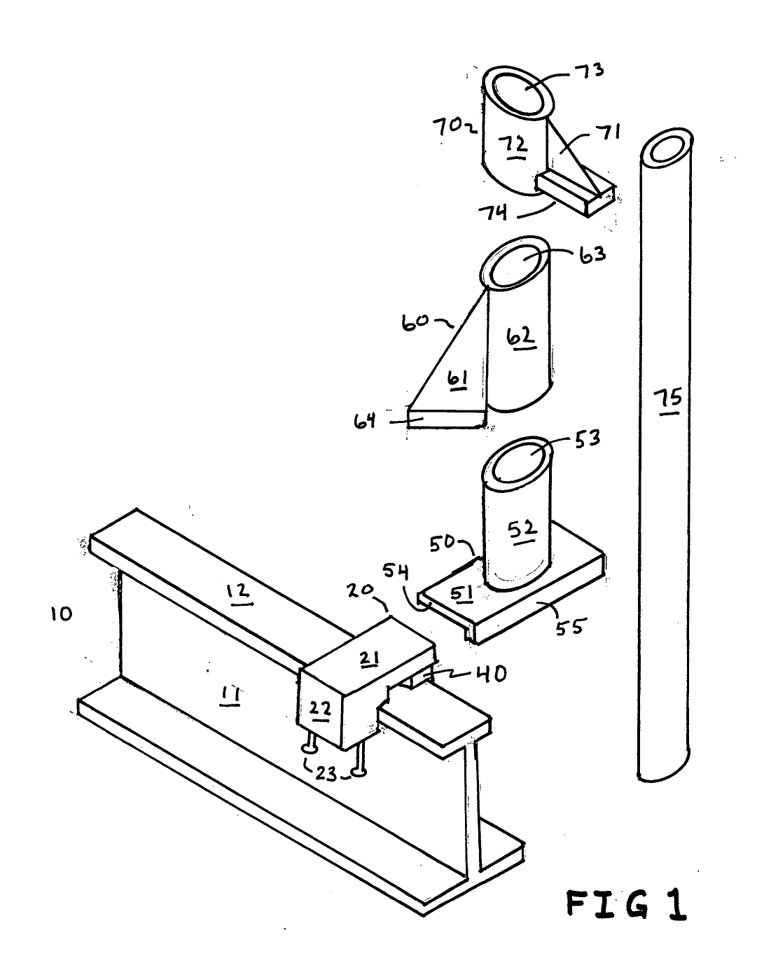

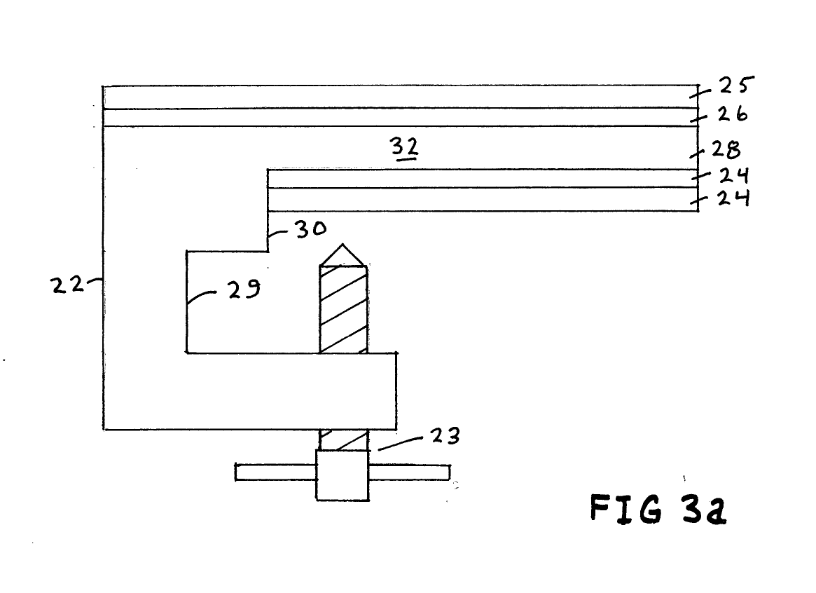

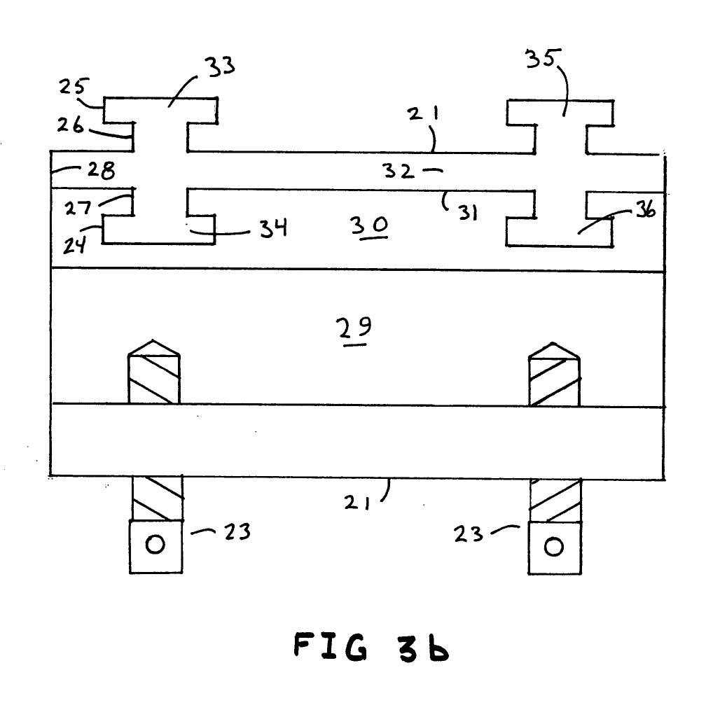

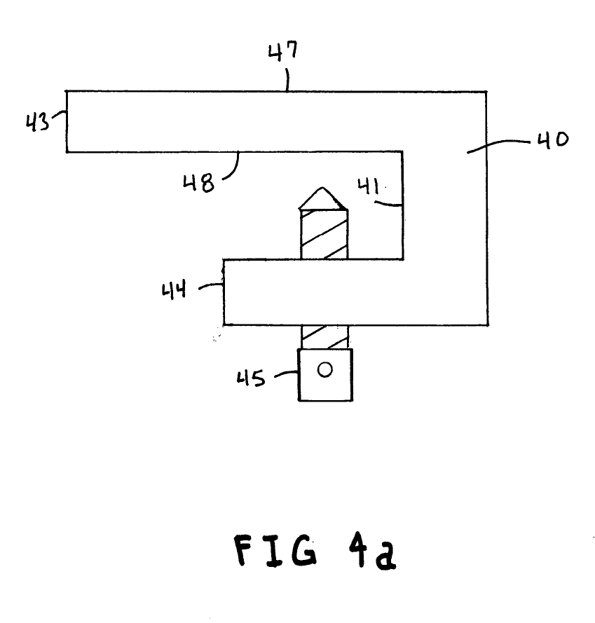

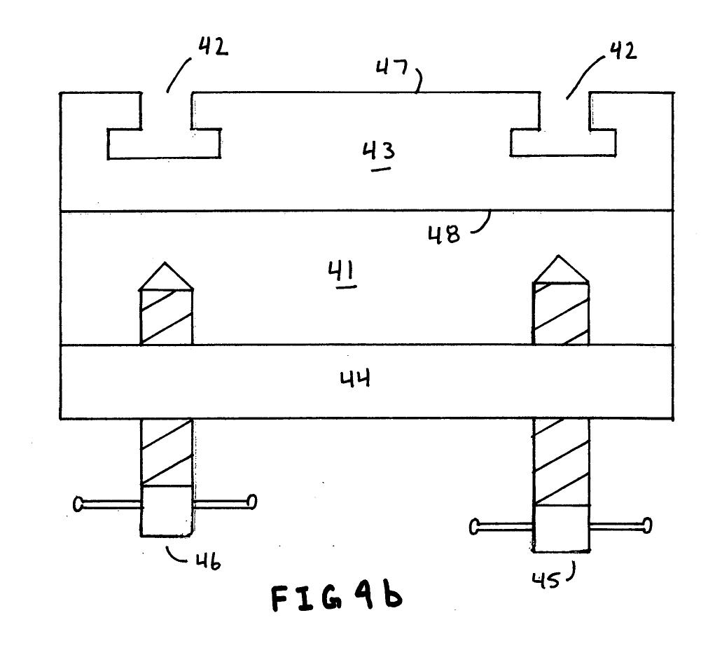

Referring now to the figures, there is in FIG. 1 an embodiment of an apparatus of the present invention. Depicted is a structural I-beam 10 made of web 11 and flange 12, to which the apparatus attaches. Two clamp components, clamp members 20 and 40 fit together to act in a clamping manner to hold onto flange 12. In this view there is shown making up a portion of clamp member 20 the elements of a top surface 21, an end surface 22, and set bolt members 23. Engaging clamp member 20 is clamp member 40, which interlocks by means not shown in FIG. 1 but depicted in FIGS. 3 and 4, as hereinafter explained. Also shown is a slide plate 50 having a top surface 51, receiving pipe 52 with an opening 53, end surface 54 and side surface 55. Top surface 51 can be solid or open below pipe 52 so as to either respectively block complete passage of a structure inserted into pipe 52 or permit such. Slide plate 50 and clamp member 20 interlock by means not shown in FIG. 1 but depicted in FIGS. 3 and 5, as hereinafter explained. Also shown are brackets 60 and 70. Bracket 60 has a receiving pipe 62 with opening 63, flange 61 and arm 64. In this embodied version arm 64 is a hollow square tube suitable for receiving a clamping mechanism as later described. Bracket 70 similarly has a receiving pipe 72 with opening 73, flange 71 and arm 74. Brackets 60 and 70 differ from each other in this version in that flange 61 extends below the bottom opening (not shown) of pipe 62 so that arm 64 does not attach directly to pipe 62. Flange 71 is such that arm 74 attaches directly to pipe 72. When support 75 is inserted sequentially through openings 73, 63 and 53, arm 64 can be position to rest against the outer surface of pipe 52. Not shown in FIG. 1 are the mechanism by which these components become relatively fixed when in use.

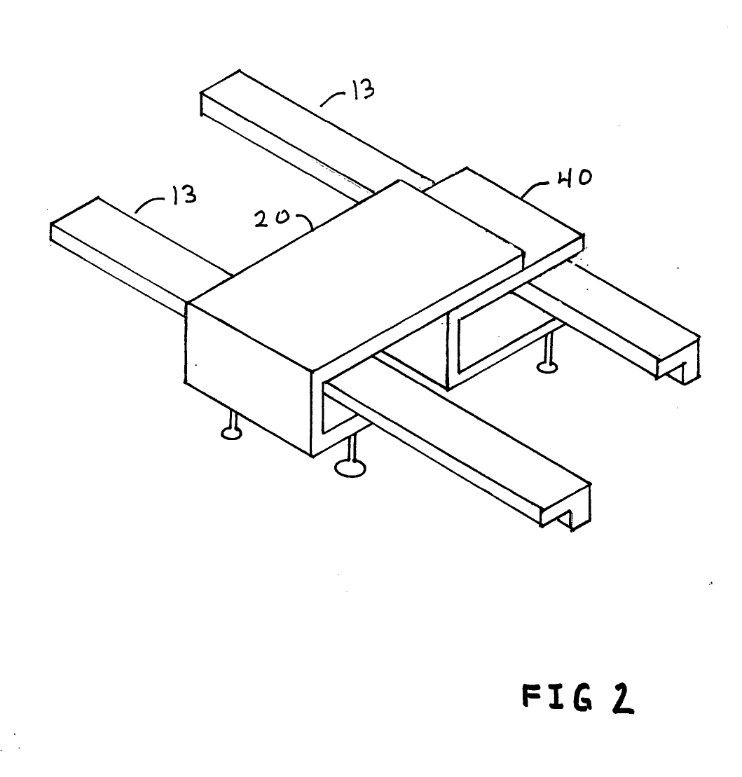

In FIG. 2 there is shown an alternative arrangement for use of the present apparatus when used in conjunction with two parallel L-beams, e.g. angle irons 13. In this configuration, the relative positions of clamp members 20 and 40 are reversed but still interlock as described hereinafter.

In FIGS. 3a and 3b there are depicted respectively a side view and an end view of clamp member 20 showing an upper T-rails 33 and 35 on the surface 21 of the top plate 32 of clamp member 20 and a lower T-rails 34 and 36 on the surface 31 underneath and opposite of surface 21. Lower T-rails 34 terminates by intersecting surface 30. Also is set bolt pin 23. When clamping occurs, surface 29 is preferably biased against the edge of flange 12. The upper and lower T-rails 33 and 34 have surfaces 24, 25, 26, 27 and 28.

In FIGS. 4a and 4b there are depicted respectively a side view and an end view of clamp member 40 showing a pair of T-slots 42 for receiving the lower T-rails 34 depicted in FIGS. 3a and 3b as well as surfaces 41, 43, 44, 47 and 48. When clamp members 20 and 40 are interlocked, surface 31 is biased against surface 48 and set-pins 23, 45 and 46 are worked to bias against the undersurface of flange 12.

In FIG. 5 there is depicted slide plate 50 having an upper surface 51 to which there is attached pipe 52 having opening 53. Surface 51 is the top surface for the base plate 54 having a front edge surface 55, a lock hole 56 and a pair of T-slots 57 and 58. Lock pin 59 is inserted through lock hole 56 into an appropriate hole in the surface of upper T-rail 35.

In FIG. 6 there is depicted clamping arm 80 having a stem arm 81 suitable for insertion into either of arm 64 or arm 74. An appropriate means, not shown, of locking the relative positions of stem arm 81 in either of arms 64 or 74, such as set-pins, set-screws or bolts for example, can be used. Clamp arms 82 and 83 are each provided with a gear means 85 and pin 84 which attaches each arm to stem arm 81. The respective gear means 85 may be, but need not be, monolithically formed with each clamp arm. At the end of each clamp arm 82 or 83 here is similarly provided a clamping head 86 with a pin 87 for rotatably holding clamping head 86 to the respective clamp arm. Slot opening 88 permits use of a locking means, such as a pin or bolt, to fix the relative rotated position of each clamping head 86 to clamp arms 82 and 83. To assist in gripping a structural member there is optionally provided teethed surface 89. The bolt stem 90 of clamping bolt 93 extends through a biasing collar through a spring shell, wire or plate 92 on the outer surface of clamping arm 82. The threaded end of bolt stem 90 extends through a rotatable embedded nut within clamp arm 83.

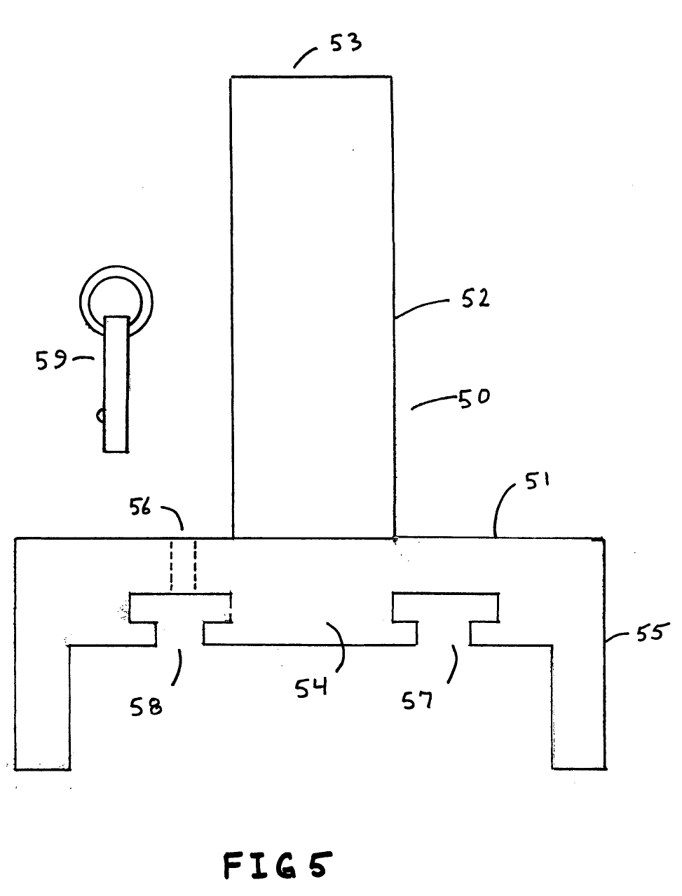

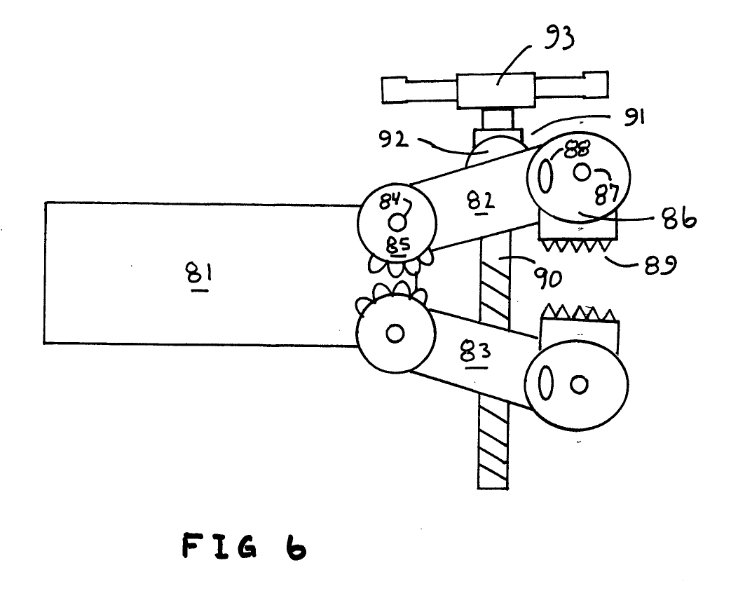

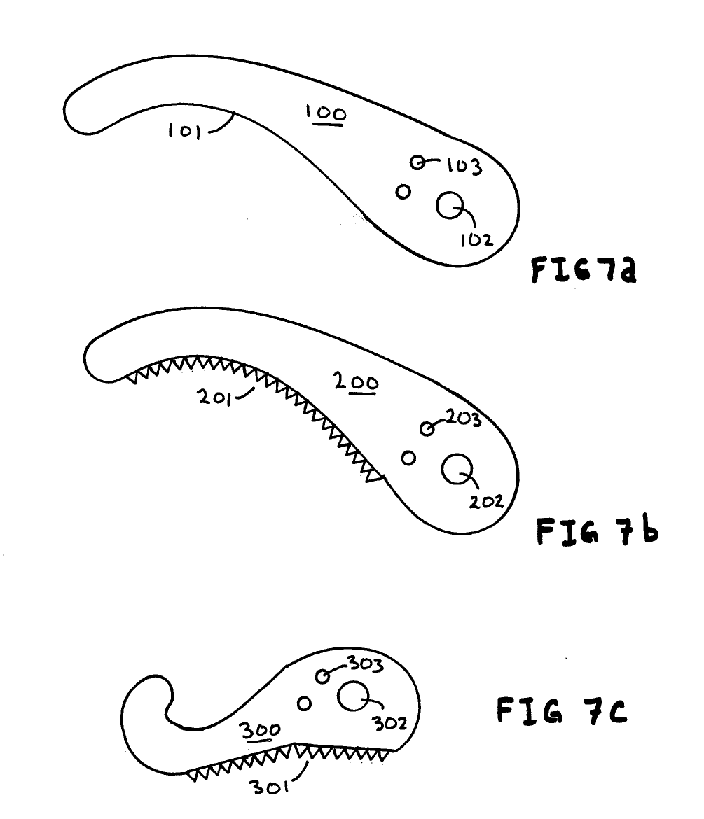

In FIGS. 7a, 7b, and 7c there are depicted further variations of clamping heads, clamping heads 100, 200 and 300, substitutable for clamping head 86. Similar to teethed surface 89 there are disclosed gripping surfaces 101, 201 and 301 to illustrate variations useable. Respectively there are disclosed pins 102, 202 and 302. Slot openings 103, 203 and 303 are shown. Reversed point 304 is provided to enable use of a chain to secure a structural member.

It is understood by those in the art that for all of the relatively moveable junctions or connections described hereinabove, that a variety of locking means are useable to temporarily secure the relative position of each item to another during use. Non-limiting examples are clamping type means; biasing means, such as springs and other biasing-expansion member; pins, turn bolts and slots or receiving holes, nuts and bolts, and other such mechanisms chosen as a matter of convenience of the user.

Another embodiment of the present invention is an apparatus for securing a first structural member relative to a second structural member. This apparatus comprises

(1) a first clamp for securing to the first structural member, the first clamp comprising a first clamp member and a second clamp member, the first and second clamp members having means to adjustably engage securely the first clamp to the first structural member;

(2) a support member;

(3) a slide plate member comprising means to adjustably securely engage to the first clamp and means to adjustably engage the support member;

(4) one or more bracket(s) having means to slideably engage the support member and having means to adjustably securely engage the second structural member.

Preferably, the apparatus is one wherein the first structural member is selected from a group consisting of an I-beam, a T-beam, a C-beam, and an L-beam. The first clamp can be configured to engage a flange of such first structural member.

Another embodiment is an apparatus for securing a set of two or more first structural members relative to a second structural member, said apparatus comprising

(1) a first clamp for securing each of said first structural member to said second structural member, said first clamp comprising two or more first clamp members, each of said clamp members having independent means to adjustably engage securely said first clamp to an independently mapped first structural member;

(2) a support member;

(3) a slide plate member comprising means to adjustably securely engage to said first clamp and means to adjustably engage said support member;

(4) one or more bracket(s) having means to slideably engage said support member and having means to adjustably securely engage said second structural member.

A non-limiting example of such apparatus is one used with two parallel angle iron structural members. In this particular use, the first clamp has one clamp member attached to one first structural member and the second clamp member attached to another first structural member. For instance, this embodiment can be, but need not be, effected by using C-clamps for the clamp members. These C-clamps can have flat plate surfaces which have slots or channels through which bolts or pins are secured after adjusting the relative positions of the clamp members.

Additionally, a slide plat member can have one or more protrusion member(s) to operatively engage said slot.

Although various preferred embodiments of the invention have been described herein in detail, it will be understood by those skilled in the art that variations may be made thereto.

What is claimed is:

1. An apparatus for securing a first structural member relative to a second structural member, said apparatus comprising
(1) a first clamp for securing to said first structural member, said first clamp comprising a first clamp member and a second clamp member, said first and second clamp members having means to adjustably engage securely said first clamp to said first structural member;
(2) a support member;
(3) a slide plate member comprising means to adjustably securely engage to said first clamp and means to adjustably engage said support member;
(4) one or more bracket(s) having means to slideably engage said support member and having means to adjustably securely engage said second structural member.

2. The apparatus of claim 1 wherein said first structural member is selected from a group consisting of an I-beam, a T-beam, a C-beam, and an L-beam; and said first clamp is configured to engage a flange of said first structural member.

3. An apparatus for securing a set of two or more first structural members relative to a second structural member, said apparatus comprising
(1) a first clamp for securing each of said first structural member to said second structural member, said first clamp comprising two or more first clamp members, each of said clamp members having independent means to adjustably engage securely said first clamp to an independently mapped first structural member;
(2) a support member;
(3) a slide plate member comprising means to adjustably securely engage to said first clamp and means to adjustably engage said support member;
(4) one or more bracket(s) having means to slideably engage said support member and having means to adjustably securely engage said second structural member.

4. The apparatus of claim 1 wherein each of said first and second clamp member is a C-clamp and said means to engage comprises a slot and a turn bolt.

5. The apparatus of claim 1 wherein said first clamp comprises a channel and a pin.

6. The apparatus of claim 1 wherein said slide plat member comprises one or more protrusion member(s) to operatively engage said slot.

7. The apparatus depicted in FIG. 1.
